(19) United States
(12) Patent Application Publication
(10) Pub. No.: US 2009/0252877 A1
(43) Pub. Date: Oct. 8, 2009

(54) METHOD FOR RENDERING COLOR IMITATION ON A BAKING TRAY

(76) Inventor: Yu Tzu Wang, Taipei (TW)

Correspondence Address: Wang Law Firm, Inc., 4989 Peachtree Parkway,, Suite 200, Norcross, GA, 30092, US

(21) Appl. No.: 12/061,235

(22) Filed: Apr. 2, 2008

(51) Int. Cl. B05D 3/02

(52) U.S. Cl. 427/318

(57) ABSTRACT

A method for rendering color imitation on a baking tray comprises steps of: cleaning an inner object-supporting surface and an outer surface of the baking tray and forming a crystalline protective film thereon; oven-drying the cleaned baking tray; spray-coating said surfaces of the oven-dried baking tray with a primer and baking the primer; spray-coating said surfaces of the baking tray with a color paint which imitates a copper or a stainless-steel color and baking the color paint; and spray-coating said surfaces of the baking tray with a transparent non-stick coating and baking the transparent non-stick coating. With the method, surfaces of a baking tray made of a low-priced, carbon-steel or cast-iron substrate can be provided with a color imitating an expensive, fine-textured material such as copper or stainless steel and a non-stick effect.

### BACKGROUND OF THE INVENTION

1. Technical Field

The present invention relates to a method for rendering color imitation on a surface of a baking tray and, more particularly, to a method for providing a surface of a low-priced carbon-steel baking tray with a color imitating an expensive, fine-textured material such as copper or stainless steel and a non-stick effect.

2. Description of Related Art

Generally, a baking tray (box) for baking cakes or pastries is formed by stretching or casting a substrate of, for example, cast iron, tinplate, aluminum alloy, copper or stainless steel, and then coating a surface of the baking tray with a synthetic resin to provide the surface with a non-stick effect.

Among baking trays made of the above-mentioned substrates, a baking tray made of cast iron requires frequent use and maintenance after use is necessary for protecting its surface, otherwise the tray will easily rust and cause sanitary concerns. Compared with cast iron, a baking tray made of tinplate will not rust so easily because tinplate itself is plated with tin during its manufacturing process. However, the tin coating, once formed and processed, can be readily damaged by scratching or collision and therefore susceptible to oxidation. Aluminum alloy, copper and stainless steel are very suitable for use in an environment where cakes are made because they do not rust and can be easily cleaned after use. Unfortunately, these materials have a very high material cost and do not provide a non-stick effect. As a result, they are good only for mass production of cakes and not appropriate for general consumers who make cakes only occasionally.

Another issue about baking trays is their exterior colors. When shopping for a baking tray, a consumer will definitely care about its shape, convenience of use, ease of cleaning and whether it will rust easily or not. And when these criteria are taken into consideration, the best choice seems to be a baking tray made of copper or stainless steel, whose natural colors and textures also make an impression of high quality products on the consumer. However, a copper or stainless-steel baking tray comes with a high price and does not provide a non-stick effect. On the other hand, if price is the only factor to be considered, a baking tray made of a low-priced material such as cast iron and tinplate will be the choice. Nevertheless, a baking tray made of such materials has an outer surface that is black (if made of cast iron) or grey (if made of tinplate or coated with a non-stick resin), instantly giving away its price range. In addition, as baking trays made of these low-priced materials are available only in such limited colors, they produce a monotonous visual effect when in use.

### BRIEF SUMMARY OF THE INVENTION

In view of the aforementioned issues of colors associated with the materials of baking trays, the present invention aims to provide a method for providing a surface of a baking tray made of a low-priced material with a color imitating an expensive material and a non-stick effect.

To achieve this end, the present invention provides a method for rendering color imitation on a baking tray, wherein the method comprises steps of: cleaning an inner object-supporting surface and an outer surface of the baking tray and forming a crystalline protective film thereon; oven-drying the cleaned baking tray; spray-coating said surfaces of the oven-dried baking tray with a primer and baking the primer at 120 to 160° C. for 5 to 10 minutes; spray-coating said surfaces of the baking tray with an imitation-color paint and baking the imitation-color paint at 120 to 160° C. for 5 to 10 minutes; and spray-coating at least one said surface of the baking tray with a transparent non-stick coating and baking the transparent non-stick coating at 250 to 300° C. for 10 to 15 minutes.

In the method for rendering color imitation described above, the steps of cleaning said surfaces of the baking tray and forming the crystalline protective film thereon comprises: cleaning said surfaces with an alkaline cleanser so as to remove metal-processing machine oil from said surfaces; and phosphatizing said surfaces with a phosphate to form the crystalline protective film. Or alternatively, the step of cleaning said surfaces of the baking tray is followed by a step of sandblasting said surfaces.

In the method for rendering color imitation described above, the baking tray is made of a carbon-steel or cast-iron substrate, while the imitation-color paint imitates a color of copper, stainless steel, or any other material.

In the method for rendering color imitation described above, the transparent non-stick coating spray-coated on said surfaces of the baking tray is a silicone, wherein the transparent non-stick coating can be spray-coated on the inner object-supporting surface only, or on both the inner object-supporting surface and the outer surface.

Using the method for rendering color imitation on a baking tray according to the present invention, a surface of a baking tray made of a low-priced substrate of, for example, carbon steel or cast iron can be provided with a visual effect resembling an expensive material such as copper or stainless steel, making it possible for a consumer to buy a fine-textured baking tray at a low price. Moreover, the various imitation colors on the caking trays add to the fun of cake baking.

### BRIEF DESCRIPTION OF THE SEVERAL VIEWS OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a flow chart of a method for rendering color imitation on a baking tray according to a preferred embodiment of the present invention; and

FIGS. 2 to 5 are perspective views of baking trays treated with the method of the present invention, wherein the baking tray in FIG. 2 has a color imitating brass, the baking tray in FIG. 3 has a color imitating red brass, and baking trays in FIGS. 4 and 5 have colors imitating stainless steel.

### DETAILED DESCRIPTION OF THE INVENTION

Generally, a baking tray can be formed by two approaches, namely post-coating (i.e., coating is performed after a baking tray is formed) and pre-coating (i.e., a flat plate is bake-coated before it is stretch-formed into a baking tray). A baking tray with imitation colors provided according to the present invention is formed by the post-coating approach.

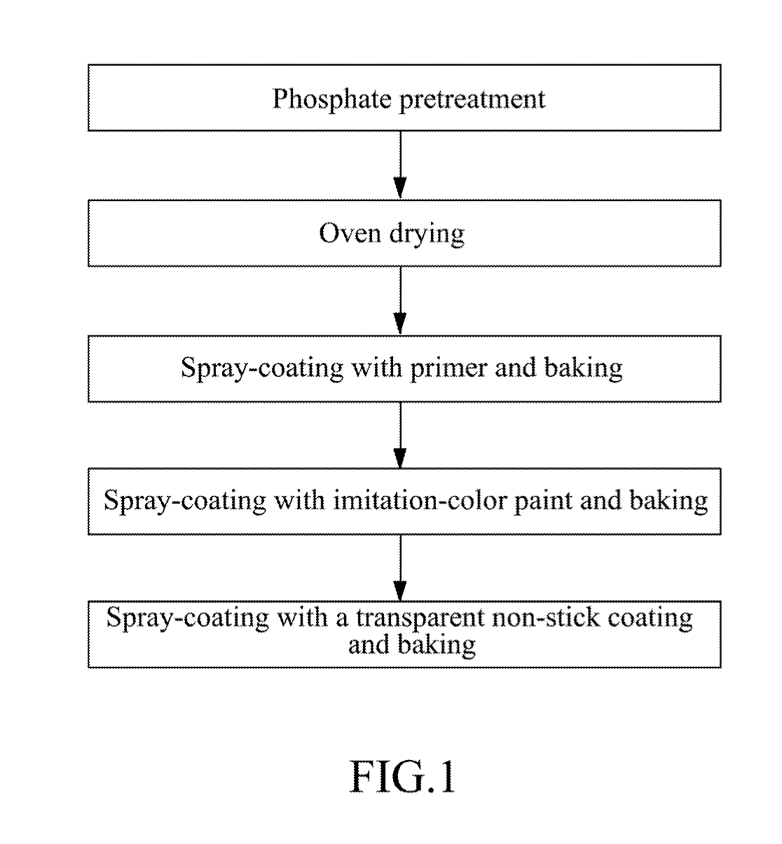

Refer to FIG. 1 for a flow chart of a method for rendering color imitation on a baking tray according to a preferred embodiment of the present invention, wherein the method comprises the following steps:

Phosphate Pretreatment

A formed and unpainted baking tray is cleaned with an alkaline cleanser to remove residual metal-processing machine oil from an inner object-supporting surface and an outer surface of the baking tray. The surfaces are then phosphatized by a chemical, such as a phosphate, to form a crystalline protective film thereon.

Oven Drying

The cleaned baking tray is put in a drying oven of 160 to 220° C. for 5 to 20 minutes to remove water thereon. The baking temperature and time can be adjusted according to a thickness and shape of the baking tray.

Spray-Coating with Primer and Baking

The inner object-supporting surface and the outer surface of the oven-dried baking tray are spray-coated with a primer, which is then baked at 120 to 160° C. for 5 to 10 minutes.

Spray-Coating with Imitation-Color Paint and Baking

The inner objective-supporting surface and the outer surface of the baking tray are spray-coated with an appropriate color paint according to a desired imitation-color on the baking tray (such as a copper color or a stainless-steel color). The paint is then baked at 120 to 160° C. for 5 to 10 minutes.

Spray-Coating with a Transparent Non-Stick Coating and Baking

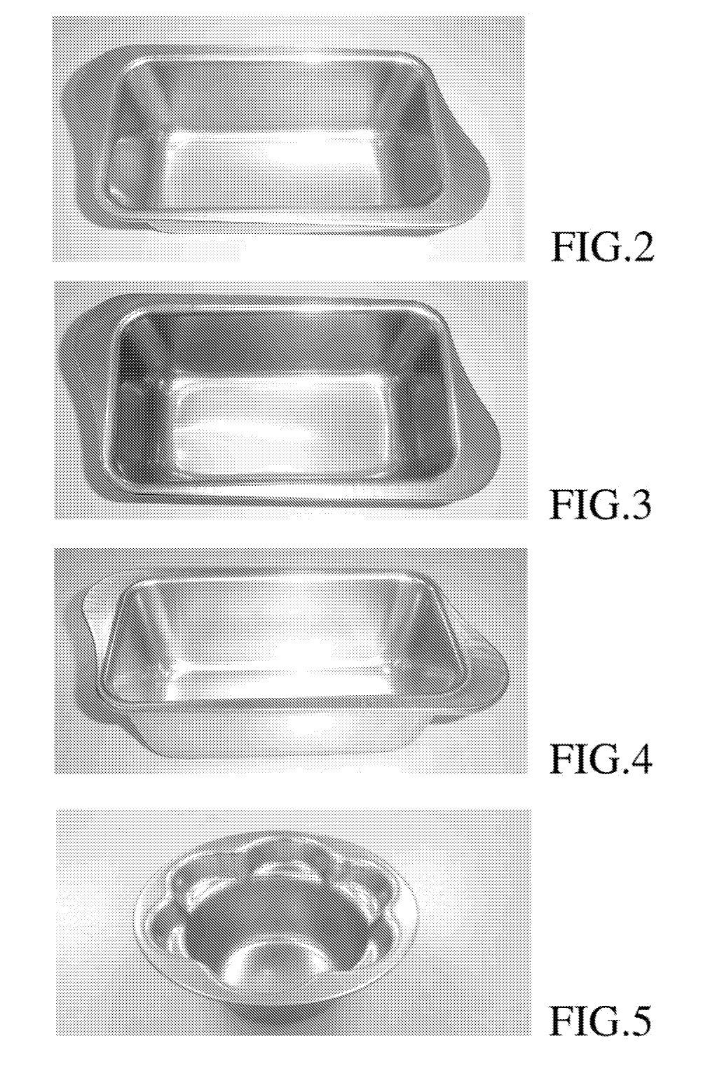

The inner objective-supporting surface and the outer surface of the baking tray, or the inner object-supporting surface alone, is spray-coated with a transparent non-stick coating such as a silicone. The transparent non-stick coating is then baked at 250 to 300° C. (preferably 280° C.) for 10 to 15 minutes to be solidified, so that the color on said surface(s) of the baking tray bears a greater resemblance to the material it imitates. For example, the baking trays in FIGS. 2 to 5 have a brass color (FIG. 2), a red-brass color (FIG. 3) and a stainless-steel color (FIGS. 4 and 5), respectively.

Therefore, a baking tray can be made of a substrate selected from low-priced materials, such as carbon steel and cast iron, and then treated with the foregoing steps to obtain an imitation color. As a result, a baking tray made of a low-priced material can be treated at will to imitate a baking tray made of an expensive, fine-textured material such as copper, stainless steel or any other material, meeting a consumer's considerations in product texture and price at the same time.

In the preferred embodiment of the present invention described above, the transparent non-stick coating is spray-coated on the inner object-supporting surface and the outer surface of the baking tray. However, under the consideration of cost, the transparent non-stick coating can be applied only to the inner object-supporting surface of the baking tray.

The present invention has been described with the preferred embodiment thereof and it is understood that the embodiment is not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

1. A method for rendering color imitation on a baking tray, comprising steps of:
cleaning an inner object-supporting surface and an outer surface of the baking tray;
oven-drying the cleaned baking tray;
spray-coating said surfaces of the oven-dried baking tray with a primer and baking the primer at 120 to 160° C. for 5 to 10 minutes;
spray-coating said surfaces of the baking tray with an imitation-color paint and baking the imitation-color paint at 120 to 160° C. for 5 to 10 minutes; and
spray-coating at least one said surface of the baking tray with a transparent non-stick coating and baking the transparent non-stick coating at 250 to 300° C. for 10 to 15 minutes.

2. The method for rendering color imitation on the baking tray as claimed in claim 1, wherein the step of cleaning said surfaces of the baking tray comprises: cleaning said surfaces with an alkaline cleanser so as to remove metal-processing machine oil from said surfaces; and phosphatizing said surfaces with a phosphate to form the crystalline protective film.

3. The method for rendering color imitation on the baking tray as claimed in claim 1, wherein the step of cleaning said surfaces of the baking tray comprises: cleaning said surfaces with an alkaline cleanser so as to remove metal-processing machine oil from said surfaces; and sandblasting said surfaces.

4. The method for rendering color imitation on the baking tray as claimed in claim 1, wherein the cleaned baking tray is oven-dried at 160 to 220° C. for 5 to 20 minutes.

5. The method for rendering color imitation on the baking tray as claimed in claim 1, wherein the baking tray is made of a carbon-steel or cast-iron substrate.

6. The method for rendering color imitation on the baking tray as claimed in claim 1, wherein the imitation-color paint imitates a copper color or a stainless-steel color.

7. The method for rendering color imitation on the baking tray as claimed in claim 1, wherein the transparent non-stick coating on said surfaces of the baking tray is baked at 280° C.

8. The method for rendering color imitation on the baking tray as claimed in claim 1, wherein the transparent non-stick coating spray-coated on said surfaces of the baking tray is a silicone.

9. The method for rendering color imitation on the baking tray as claimed in claim 1, wherein the transparent non-stick coating is spray-coated on the inner object-supporting surface of the baking tray.

10. The method for rendering color imitation on the baking tray as claimed in claim 1, wherein the transparent non-stick coating is spray-coated on the inner object-supporting surface and the outer surface of the baking tray.
